(19) United States
(12) Patent Application Publication
(10) Pub. No.: US 2025/0374354 A1
(43) Pub. Date: Dec. 4, 2025

(54) IMPROVING DATA CONNECTIONS OF USER EQUIPMENTS IN A MOBILE NETWORK

(71) Applicant: Continental Automotive Technologies GmbH, Hannover (DE)

(72) Inventors: Hojin Kim, Regensburg (DE); Rikin Shah, Langen (DE); David Gonzalez Gonzalez, Egelsbach (DE)

(73) Assignee: Continental Automotive Technologies GmbH, Hannover (DE)

(21) Appl. No.: 18/870,978

(22) PCT Filed: May 17, 2023
(86) PCT No.: PCT/EP2023/063317

§ 371 Date: Dec. 2, 2024

(30) Foreign Application Priority Data
Jun. 2, 2022 (DE) 10 2022 205 636.1

(51) Int. Cl. H04W 76/15; H04W 24/10; H04W 76/28; H04W 92/20

(52) U.S. Cl. CPC H04W 76/15; H04W 24/10; H04W 76/28; H04W 92/20

(57) ABSTRACT

The present disclosure relates to a User Equipment (UE) having a connection with a Master Node (MN) and a Secondary Node (SN). The SN notifies the UE of an upcoming switched-off period, in which it will not be available for communication with the UE. If the UE needs to communicate with a SN during that period, it will try to establish a new connection with a new SN. To do so, it will send information about its communication-on period, in which it needs to communicate with a SN, and information about the switch-off period to its MN. The MN will determine one or more possible new SNs on the basis of the information about the communication-on period of the UE and information about the switch-on periods of other SNs. The MN send information about possible new SNs to the UE, which selects one of those for establishing a new connection.

### CROSS-REFERENCE TO RELATED APPLICATIONS

The present application is a National Stage Application under 35 U.S.C. § 371 of International Patent Application No. PCT/EP2023/063317 filed on May 17, 2023, and claims priority from German Patent Application No. 10 2022 205 636.1 filed on Jun. 2, 2022, in the German Patent and Trademark Office, the disclosures of which are herein incorporated by reference in their entireties.

### TECHNICAL FIELD

The invention relates to a method for improving the data connection of a UE (User Equipment) in a mobile network.

### BACKGROUND

In a mobile network, a UE, for example a mobile phone, may be connected to a first base station, which in turn may be connected to servers in the cloud. This enables the UE to exchange data with these servers. The UE may also be connected to a second base station, which in turn may also be connected to these or other servers, in order to extend its possibilities to exchange data with these servers, for example in terms of bandwidth or in terms of a Quality of Service (QOS) of the connections.

One of the base stations may be referred to as the Master Node (MN) for the UE, while the other may be referred to as the Secondary Node (SN) for the UE. The MN may be arranged for managing the connection between the UE and the MN, but also the connection between the UE and the SN.

However, if the SN is unable to forward data from the UE to the servers in the cloud, the data connection of the UE may be reduced in bandwidth or in terms of Quality of Service (QOS). The objective of the present disclosure is to improve the data connection of a UE in a mobile network.

### SUMMARY

The objective of the present disclosure is addressed in providing a method according to claims 1, 4, 6 and 9 and a UE according to claim 13 and a network node according to claim 14.

According to a first aspect, a method for improving the data connection of a UE (User Equipment) in a mobile network, to be executed by a UE, is provided, including the steps of:
establishing a first connection between the UE and a MN (Master Node) of the mobile network;
receiving, from the MN using the first connection, connection information for establishing a second connection between the UE and a SN (Secondary Node);
establishing a second connection between the UE and the SN based on the connection information,
wherein during a communication-on time period the UE is to communicate with the SN and during a communication-off time period the UE is not to communicate with the SN;
wherein during a switch-on time period the SN is able to communicate with the UE and during a switch-off time period the SN is unable to communicate with the UE;
receiving a switch-off message from the SN using the second connection, indicating an upcoming switch-off period of the SN;
determining a mismatch between the upcoming switch-off period of the SN and a communication-on period of the UE;
in response to a determined mismatch, the method further includes the following steps:
a) sending an extension request to the SN, wherein the request includes an extension time for extending its switch-on period;
   and/or,
b) sending information about the communication-on period and information about the upcoming switch-off period, to the MN using the first connection and/or to the SN using the second connection, wherein the SN is arranged for forwarding the information to the MN using a third connection between the SN and the MN;
receiving from the MN new connection information for establishing a new second connection between the UE and a new SN; wherein the new connection information includes information about at least one new SN;
selecting a new SN from the at least one new SN;
establishing a new second connection with the selected new SN.

A User Equipment may be vehicle that is arranged for connecting to a communication network, a mobile telephone or any other device that is arranged for connecting to a communication network, such as a wireless network. Examples of such a communication network are cellular mobile networks, networks as defined by 3GPP, a WLAN, a Bluetooth network and DSRC networks.

Since the MN manages the connection between UE and the SN, it is the MN that sends information to the UE for establishing this connection.

In general, nodes in a network may be arranged for being temporarily and at least partly switched-off in order to save on energy. In that case, the node will be (partly) switched off and unable to communicate with its UEs during a so-called switch-off period. During a switch-on period the node is switched-on and able to communicate with its UEs. A node is either in a switch-off period or in a switch-on period.

In one or more embodiments, the sequence of switch-on and switch-off periods may be a periodically at least for some time period. In other embodiments, this sequence may be non-periodically. In one or more embodiments, the sequence of switch-on and switch-off periods is determined by the network, for example in order to comply with certain energy savings targets.

A UE may be arranged to be in communication-on time period or in communication-off time period. During a communication-on time period the UE is to communicate with an SN and during a communication-off time period the UE is not to communicate with the SN. In one or more embodiments, the sequence of communication-on and communication-off periods may be periodically at least for some time period. In other embodiments this sequence may be non-periodically.

In one or more embodiments, the sequence of communication-on and communication-off periods is determined by the UE, for example on the basis of buffer load in the UE or an estimated future data load that needs to be communicated with remote servers using the SN.

In case the SN is scheduled to enter a switch-off period, it may communicate that by sending a switch-off message to the UE. When the UE is in a communication-on period, the UE may compare its communication-on period with the scheduled switch-off period and determine a mismatch, meaning that the UE is scheduled to communicate with SN after the SN has entered a switched-off period.

In response to the determined mismatch, the UE may be arranged to react in one or more of the following ways:
1) The UE may send an extension request to the SN for delaying the start of its switch-off period, such that the UE will be able to complete its communication-on period before the start of the switch-off period. In that way, the UE may continue and communicate the data it had scheduled.
2) The UE may try to connect to another SN that is not entering a switch-off period before the end of the communication-on period of the UE. In that way, the UE may establish a new connection with a new SN and communicate at least part of the data it has scheduled using the new SN.

Since the connection between the UE and SNs are managed by the MN, the UE may be arranged to indicate the mismatch or its need to connect to another SN to the MN using its (direct) first connection to the MN.

However, it may be the case that this first connection is not so reliable because of a high data load or fluctuating QoS of the first connection. Therefore, the UE may be arranged for additionally or alternatively indicate the mismatch or its need to the MN using its second connection (with the SN). The SN is arranged for forwarding or relaying this information to the MN, for example using a wired connection between the SN and the MN.

The need to connect to another SN may be communicated to the MN by sending information about the communication-on period and information about the upcoming switch-off period.

In one or more embodiments, the information about the upcoming switch-off period is communicated as a part of a Measurement Report, generated by the UE. In one more embodiment, receiving the switch-off message in the UE may trigger generating a Measurement Report by the UE.

Based on this information and information from one or more other SNs, indicating their respective current switch-on period and/or upcoming switch-off period, the MN may determine one or more new SNs on the basis of one or more predetermined criteria.

In one or more embodiments, information about the one or more other SNs is received by the MN as part of the Measurement Report, generated by the UE.

In one or more embodiments, a predetermined criterium may be that for each new SN its respective switch-on period ends after the communication-on period. Additionally, or alternatively, a predetermined criterium may be that for each new SN its respective switch-on period ends after a predetermined threshold time. In one or more embodiments, the predetermined threshold time is determined based on information about the QoS of one or more services running in the UE and/or a status of a data buffer in the UE and/or an estimated future data load that needs to be communicated with remote servers.

The MN may transmit to the UE new connection information for establishing a new second connection between the UE and a new SN, wherein the new connection information includes information about the determined one or more new SNs.

After receiving the new connection information, the UE may select a new SN from the at least one new SN and establish a new second connection with the selected new SN. In one or more embodiments, the new SN is selected from the at least one new SN on the basis of the quality of the signals received in the UE from the respective new SN.

According to another aspect of the present disclosure, a method for improving the data connection of a UE (User Equipment) in a mobile network, such as to be executed by a Master Node, includes the steps of:
establishing a first connection between the UE and a MN (Master Node) of the mobile network;
transmitting, to the UE using the first connection, connection information for establishing a second connection between the UE and a SN (Secondary Node);
wherein during a communication-on time period the UE is to communicate with the SN and during a communication-off time period the UE is not to communicate with the SN;
wherein during a switch-on time period the SN is able to communicate with the UE and during a switch-off time period the SN is unable to communicate with the UE;
receiving information about a communication-on period of the UE and information about an upcoming switch-off period of the SN, from the UE using the first connection or from the SN using a third connection, wherein the SN is arranged for forwarding the information received from the UE to the MN using a third connection between the SN and the MN;
receiving information from one or more other SNs, indicating their respective current switch-on period and/or upcoming switch-off period;
determining one or more new SNs on the basis of one or more predetermined criteria; and,
transmitting to the UE new connection information for establishing a new second connection between the UE and a new SN; wherein the new connection information includes information about the determined one or more new SNs.

According to another aspect of the present disclosure, a method for improving the data connection of a group of multiple UEs (User Equipment) in a mobile network, such as executed by a MN, is provided, including the steps of:
establishing multiple first connection between the multiple UEs and a MN (Master Node) of the mobile network;
transmitting, to each of the multiple UEs using the multiple first connections, respective connection information for establishing second connections between a respective UE and a respective SN (Secondary Node);
   wherein during a communication-on time period a UE of the multiple UEs is to communicate with the SN and during a communication-off time period the UE is not to communicate with the SN;
   wherein during a switch-on time period a SN of the multiple SNs is able to communicate with its UEs and during a switch-off time period the SN is unable to communicate with the multiple UEs;
receiving information about an upcoming switch-off periods of one or more SNs of the multiple SNs;
grouping one or more UEs in one or more groups on the basis of one or more grouping criteria;
determining a new SN for each group of UEs on the basis of one or more predetermined criteria; and,
transmitting to each UE of each group of UEs new connection information for establishing a new second connection between the respective UE and a new SN that was determined for the respective group.
   By grouping the UE, it may require less processing power for the MN to find a new SN for multiple UE than for the MN to find a new SN for each UE separately.

In one or more embodiments, the one or more UEs each have established a second connection with the one or more SNs of which information about an upcoming switch-off periods had been received. In this embodiment only for UEs that have a second connection with a SN that has sent a switch-off message, a new SN will be determined, i.e., only for those UEs that could be affected by the upcoming switch-off period.

In one or more embodiments, the one or more UEs may also include UEs that have a second connection to other SNs, i.e., SNs of which no information about an upcoming switch-off periods had been received. In this embodiment not only for those UEs that could be affected by the upcoming switch-off period, but for more UEs a new SN may be determined. This would further optimize the assignment of UEs to SNs, but would also require more processing power in the MN.

In one or more embodiments, the information about an upcoming switch-off periods of one or more SNs of the multiple SNs are periodically transmitted by the respective SN to the MN.

According to one or more embodiments, the grouping criteria may be based on (or includes) at least one of a group including of:
an end of communication-on period of the respective UE;
QoS and/or priority of one or more services running in the respective UE;
status of an upload data buffer in the respective UE,
status of a download buffer for the UEs

According to one or more embodiments, the predetermined criteria includes at least one of a group including of:
for each new SN for a group of UEs, its respective switch-on period ends after all communication-on period of all UEs in the group
for each new SN for a group of UEs its respective switch-on period ends after a predetermined threshold time Tₜₕ, wherein the predetermined threshold time Tₜₕ may be determined based on information about the Qos of one or more services running in the UEs of the group and/or a status of data buffers of the UEs of the group.

According to a further aspect, a method for improving the data connection of a UE (User Equipment) in a mobile network, such as executed in a SN, is provided, the method including the steps of:
establishing a second connection between the UE and the SN,
   wherein during a communication-on time period the UE is to communicate with the SN and during a communication-off time period the UE is not to communicate with the SN;
   wherein during a switch-on time period the SN is able to communicate with the UE and during a switch-off time period the SN is unable to communicate with the UE;
sending a switch-off message to the UE using the second connection, indicating an upcoming switch-off period of the SN;
   wherein the method further includes the following steps:
a) receiving an extension request from the UE, wherein the request includes an extension time;
extending the current switch-on period with the extension time, and/or
b) receiving information about a communication-on period and information about an upcoming switch-off period from the UE using the second connection; and,
forwarding the information to the MN using a third connection between the SN and the MN.

In one or more embodiments, the information about the upcoming switch-off period is received and forwarded as a part of a Measurement Report, generated by the UE.

In one or more embodiments, the first connection is a cellular mobile network connection and/or the second connection is a cellular mobile network connection, and/or the third connection is one of a group including: a wireless connection and a wired network connection, such as an X2 connection.

In one or more embodiments, the communication-on time of a UE period is a so-called DRX-on period and the communication-off time period of a UE is a so-called DRX-off period; and/or the information about the communication-on period is sent as part of DRX configuration information, wherein the DRX-on period and the DRX-off period may be determined by the MN based on DRX configuration parameter information. In this, DRX stands for Discontinuous Reception.

According to another aspect of the present disclosure, a User Equipment (UE) is provided, which is arranged for operating in a mobile network, including:
at least one communication unit for establishing connections between the UE and a Master Node (MN) and between the UE and a Secondary Node (SN);
a processing unit for carrying out steps of a computer program;
a computer-readable medium having stored thereon a computer program, including instructions which, when the program is executed by the processing unit, cause the UE to carry out the steps of any method described in this document as being executed by a UE.

According to another aspect of the present disclosure, a network node arranged for operating in a mobile network is provided, the network node including
at least one communication unit for establishing connections between the node and at least one UE and between the node and at least one other node;
a processing unit for carrying out steps of a computer program;
a computer-readable medium having stored thereon a computer program, including instructions which, when the program is executed by the processing unit, cause the node to carry out the steps of any method described in this document as being executed by a Master Node (MN) and/or a Secondary Node (SN).

According to another aspect of the present disclosure, a computer-readable medium is provided, the medium having stored thereon a computer program, including instructions which, when the program is executed by a computer, cause the computer to carry out the steps of any method as described in this embodiment.

The working, advantages and embodiments of the UE, the SN and the MN as well as the working, advantages and embodiments of the computer program and computer-readable medium, correspond with the working, advantages and embodiments of the method as described in this document, mutatis mutandis.

### BRIEF DESCRIPTION OF THE DRAWINGS

For a more complete understanding of the present disclosure, reference in the following description is made to the accompanying drawings in which:

FIG. 1 shows a schematic overview of a use case involving a UE connecting to a MN, a SN and a new SN according to one or more embodiments of the present disclosure;

FIG. 2 shows a schematic overview of a UE according to one or more embodiments of the present disclosure;

FIG. 3 shows a schematic overview of a network node (a MN or a SN) according to one or more embodiments of the present disclosure;

FIG. 4 shows a schematic overview of a method according to one or more embodiments of the present disclosure to be executed in a UE;

FIG. 5 shows a schematic overview of a method according to one or more embodiments of the present disclosure to be executed in a MN;

FIG. 6 shows a schematic overview of a method according to one or more embodiments of the present disclosure to be executed in a SN;

FIG. 7 shows a schematic overview of an example of communication-on/off periods of a UE and switch-on/off periods of an SN;

FIG. 8 illustrates the selection of new SNs according to one or more embodiments of the present disclosure showing switch-on/off periods of multiple SNs; and,

FIG. 9 shows another schematic overview of a method according to one or more embodiments of the present disclosure to be executed in a MN.

### DETAILED DESCRIPTION

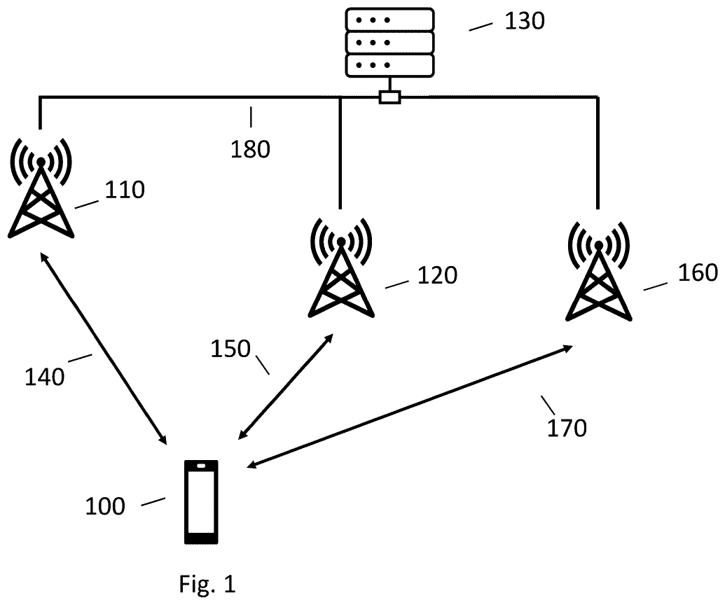

FIG. 1 shows a schematic overview of a use case involving a UE 100 connecting to a MN 110, a SN 120 and a new SN 160 according to one or more embodiments of the present disclosure. In FIG. 1, MN 110 is connected to UE 100 using a first connection 140. UE 100 is connected to SN 120 using a second connection 150 and connected to new SN 160 using a new second connection 170. MN 110, SN 120 and new SN 160 are connected using a third connection 180.

UE 100 may be arranged for communicating with cloud server 130 using first connection 140 and/or second connection 150, 170. In the Figures, UE 100 is represented by a mobile phone symbol, but UE 100 may also a vehicle, wherein a vehicle may be a car, a truck, a motorcycle, or a bus.

In one or more embodiments, first connection 140 is a cellular mobile network connection and/or second connection 150 is a cellular mobile network connection, and/or third connection 180 is a wired network connection, such as an X2 connection.

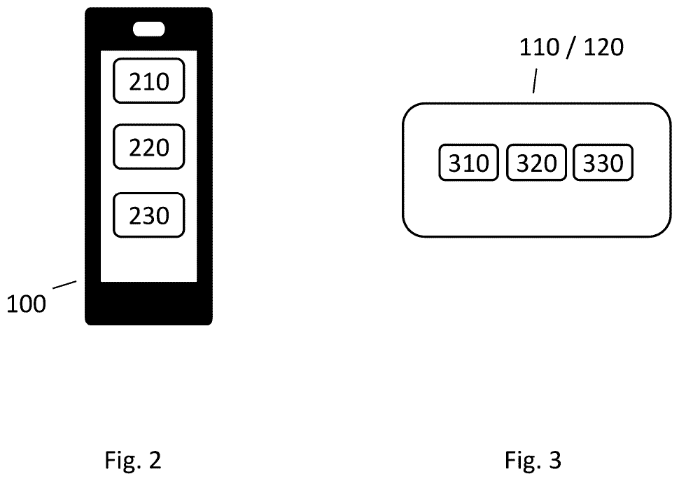

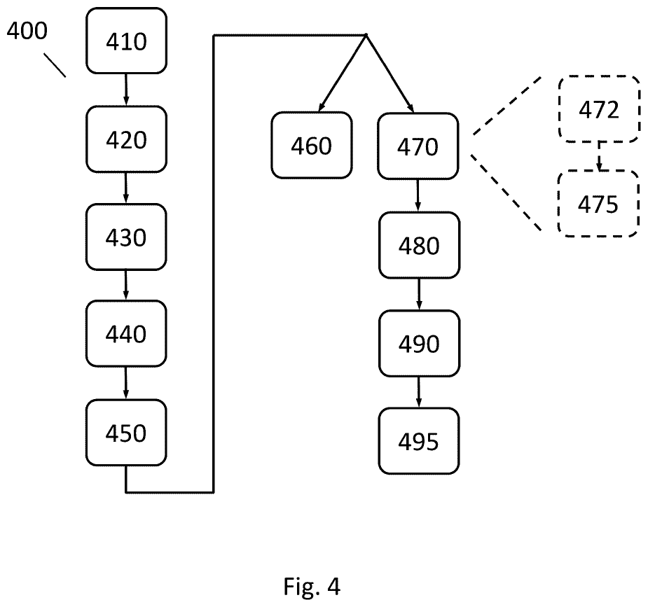

FIG. 2 shows a schematic overview of a UE according to one or more embodiments of the present disclosure. The UE 100 includes at least one communication unit 210 for establishing connections between UE 100 and MN 110 and between UE 100 and a SN 120,160. It further includes a processing unit 220 for carrying out steps of a computer program, that is stored on a computer-readable medium 230. The computer program includes instructions which, when the program is executed by the processing unit, cause UE 100 to carry out the steps of the method 400 as described with reference to FIG. 4.

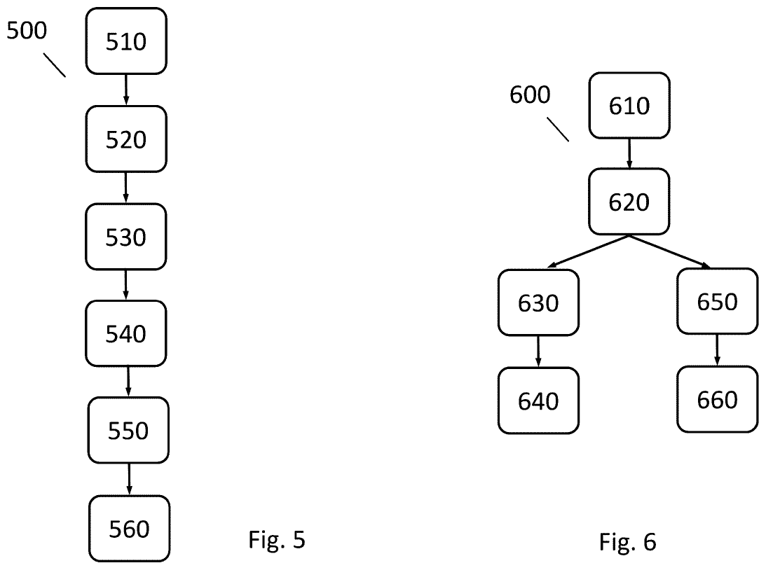

FIG. 3 shows a schematic overview of a network node, which may be an MN 110, an SN 120 or a new SN 160, according to one or more embodiments of the present disclosure. The network node 110, 120, 160 includes at least one communication unit 310 for establishing connections between node 110, 120, 160 and at least one UE 100 and between the node 110, 120, 160 and at least one other node 160, 120, 110. It further includes a processing unit 320 for carrying out steps of a computer program, that is stored on a computer-readable medium 330. The computer program includes instructions which, when the program is executed by the processing unit, cause the network node to carry out the steps of the method as described with reference to FIG. 5, the network node being an MN or the steps of the method as described with reference to FIG. 6, the network node being an SN.

With reference to FIG. 1 and FIG. 4, the following steps of method 400 will be described to be executed by UE 100:

In step 410, a first connection 140 between UE 100 and MN 110 of a mobile network is established. In step 420, connection information for establishing a second connection 150 between UE 100 and SN 120 is received receiving from MN 110 using first connection 140. In step 430, a second connection 150 between UE 100 and SN 120 is established based on the connection information.

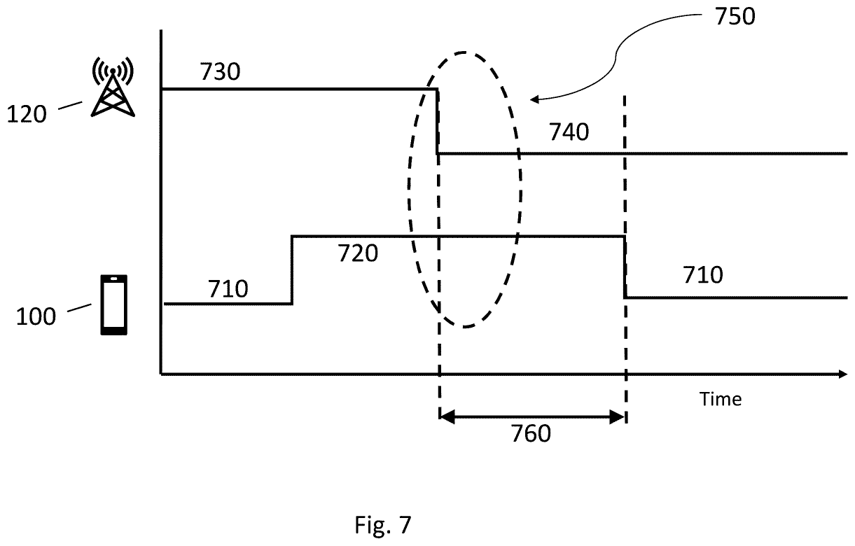

As is illustrated in FIG. 7, UE 100 may be arranged for communicating with the SN 120 during a communication-on time period 720. During a communication-off time periods 710 UE 100 is not to communicate with SN 120. SN 120 may be arranged for communicating with UE 100 during a switch-on time 730 and may be unable to communicate with UE 100 during a switch-of time 740.

A mismatch may occur when UE 100 is planning to communicate during its communication-on period 720 with SN 120 during its switch-off period 740. This is indicated in FIG. 7 by 750.

In one or more embodiments, the communication-on period 720 of UE 100 is a DRX-on period, and the communication-off 710 period is a DRX-off period. Information about these periods is sent as part of DRX configuration information. In one or more embodiments, the DRX-on period 720 and DRX-off period 710 are determined by MN 110, and may be based on DRX configuration parameter information

In step 440, UE 100 receives a switch-off message from SN 120 using the second connection 150 indicating upcoming switch-off 740 period of SN 120. In step 450, a mismatch between upcoming switch-off period 740 and a communication-on period 720 of UE 100 is determined.

In response to a determined mismatch, UE 100 may react in one or more of the following ways.

UE 100 may, in step 460, send an extension request to the SN 120, which includes an extension time 760 for extending the switch-on period 730, such that the extended switch on period ends after the communication-on period 720.

UE 100 may in step 470, send information about communication-on period 720 and information about upcoming switch-off period 740 to MN 110 using the first connection 140. In addition, or as an alternative, UE 100 may send this information to MN 110 using the second connection 150 wherein SN 120 is arranged for forwarding or relaying this information to MN 110 using third connection 180.

In one or more embodiments, step 470 may include the following steps.

In step 472, the UE 100 may generate a Measurement Report (MR) in response to receiving the switch-off message, wherein the MR includes information about the quality of signals from network nodes, for example from MN 110, SN 120 and optionally other nodes such as SN 160.

UE 100 may add to the information about the quality of signals from network nodes in the MR, the received information about upcoming switch-off period 740 or even add the completer received switch-off messaged.

In step 475, the UE 100 may send the enriched (i.e., with the added information about the upcoming switch-off period or with the added switch-off message) MR to MN 110, using either first connection 140 or second connection 150.

Based on the received information, MN 110 will determine at least one new SN 160, 162, 165 for UE 100.

In step 480, UE 100 receives from MN 110 new connection information for establishing a new second connection 170 between UE 100 and a new SN 160, 162, 165. The new connection information includes information about at least one new SN. In step 490, a new SN 160 from the at least one new SN 160, 162, 165 is selected and in step 495, a new second connection 170 is established with selected new SN 160.

When MN 110 has determined multiple new SN, the UE 100 may be arranged for selecting a new SN out of these multiple new SNs, for example by comparing the quality of the signals from the multiple SNs. The UE 100 may then select the new SN 160 with the best signal quality.

The above may also be described from the viewpoint of the MN with reference to FIG. 5, which shows a schematic overview of a method 500 according to one or more embodiments of the present disclosure to be executed in a MN.

In step 510, MN 110 establishes first connection 140 between UE 100 and MN 110. In step 520, MN 110 transmits to UE 100 using first connection 140 connection information for establishing second connection 150 between UE 100 and SN 120.

In step 530, MN 110 receives information about a communication-on period 720 of UE 100 and information about an upcoming switch-off period 740 of SN 120. This information may be received directly from UE 100 using first connection 140 or from SN 120 using third connection 180. In one or more embodiments, this information may be included in a MR, which may also information about the quality of signals UE 100 receives from network nodes.

In step 540, MN 110 receives information from one or more other SNs, indicating their respective current switch-on period and/or upcoming switch-off period. In step 550, MN 110 determines one or more new SNs on the basis of one or more predetermined criteria.

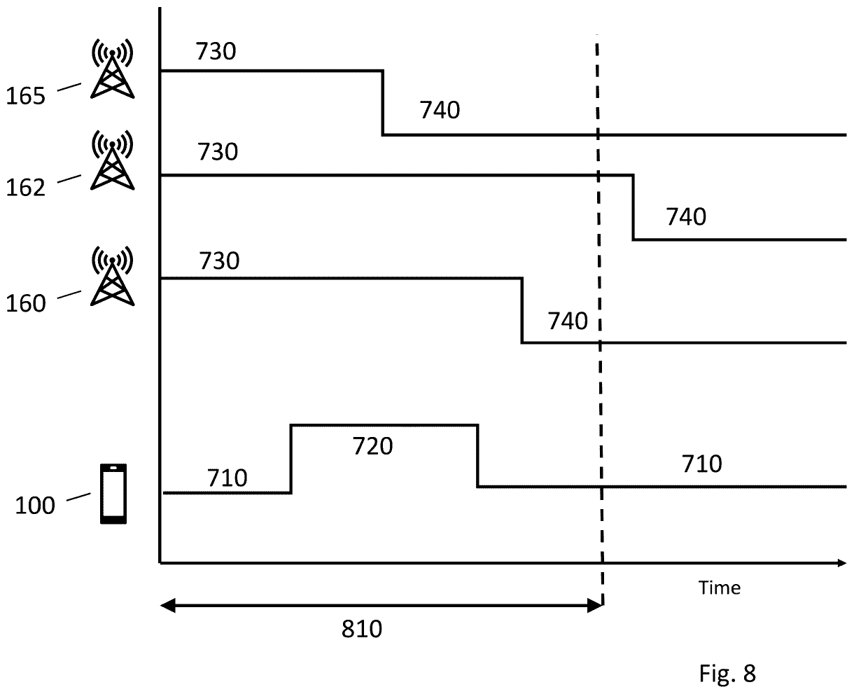

In FIG. 8, this determination is illustrated. FIG. 8 shows the communication-off period 710 and the communication-on period 720 of UE 100 and the switch-on periods 730 and the switch-off periods 740 of several SNs 160, 162, 165 that may be evaluated by MN 110 for being an alternative SN for UE 100, using the one or more predetermined criteria.

One of these criteria may be that for each new SN its respective switch-on period ends after the communication-on period. In the example of FIG. 8, that would be case for SN 160 and SN 162 but would not be the case for SN 165.

Another of these criteria may be that for each new SN its respective switch-on period ends after a predetermined threshold time Tₜₕ 810. This predetermined threshold time Tₜₕ may be determined based on information about the QoS of one or more services running in the UE and/or a status of a data buffer in the UE. In the example of FIG. 8, only SN 162 would meet this criterium.

Yet another of these criteria may be that for each new SN its respective expected data load is below a predetermined threshold load (not illustrated in FIG. 8).

In step 550, MN 110 may determine SN 160 and 162 as being suitable as a new SN for UE 100. In step 560, MN 110 transmits to UE 100 new connection information for establishing a new second connection 170 between UE 100 and a new SN, wherein the new connection information includes information about the determined one or more new SNs 160, 162.

The above may also be described from the viewpoint of SN 120 with reference to FIG. 6, which shows a schematic overview of a method 600 according to one or more embodiments of the present disclosure to be executed in a SN.

In step 610, SN 120 establishes second connection 150 between UE 100 and SN 120. In step 620, a switch-off message to UE 100 is sent by SN 120 using the second connection 150, indicating an upcoming switch-off period 740 of SN 120.

Method 600 may further include step 630, in which SN 120 receives an extension request from UE 100, which includes extension time 760. In response to the extension request, SN 120 extends current switch-on period 730 with extension time 760 in step 640.

Alternatively or additionally, method 600 may further include step 650 in which the SN 120 receives information about communication-on period 720 and information about upcoming switch-off period 740 from UE 100 using the second connection 150 and forwards the information to MN 110 in step 660 using third connection 180 between the SN 120 and the MN 110.

In one or more embodiments, the information about upcoming switch-off period 740 is received and forwarded as a part of a Measurement Report, generated by UE 100.

When a network node serves as an SN for multiple UEs and sends a switch-off message to these multiple UEs, the MN involved may need a lot of processing power in order to determine one or more new SNs for each of UEs separately.

Therefore, according to one or more embodiments of the present disclosure, an MN may determine one or more new SNs for respective groups of UEs instead of determining one or more new SNs for each UE separately.

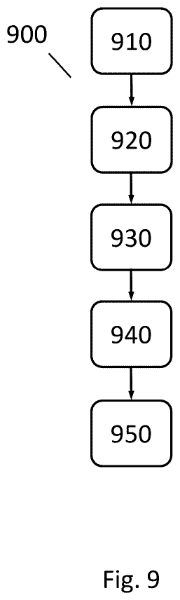

This is illustrated in FIG. 9, which shows another schematic overview of a method 900 for improving the data connection of a group of multiple UEs to be executed in MN 110, according to one or more embodiments of the present disclosure.

In step 910, the MN 110 establishes multiple first connection 140 between multiple UEs 100 and MN 110. In step 920, it transmits, to each UE, respective connection information for establishing multiple second connections between a respective UE 100 of the multiple UEs and a respective SN of multiple SNs. In step 930, MN 110 receives information about an upcoming switch-off period 740 of one or more SNs of the multiple SNs.

In step 940, MN 110 groups UEs in one or more groups on the basis of one or more grouping criteria. In one or more embodiments, the UEs to be grouped are UEs that have a second connection 150 to a SN for which MN 110 has received information about an upcoming switch-off period. Alternatively or additionally, the UEs to be grouped may be all UEs that have a first connection 140 with MN 110.

One of these grouping criteria may be based on an end of communication-on period of the respective UE. This would yield groups of UEs of which the end of their respective communication-on period falls in a group-specific range.

Likewise, when a grouping criterium is for example based on QoS of one or more services running in the UE, groups of UEs are constructed with a similar required QoS. Also, a status of an upload data buffer in a UE or a status of a download buffer for a UE may be used as a basis for grouping UEs.

In step 940, MN 110 may determine for each group of UEs a new SN of UEs on the basis of one or more predetermined criteria. These predetermined criteria for determining one or more SNs for a group of UEs may be similar to the predetermined criteria for determining one or more SNs for a single UE.

Thus, a predetermined criterium for determining one or more SNs for a group of UEs may be that for each new SN for a group of UEs, its respective switch-on period ends after all communication-on period of all UEs in the group. Or that for each new SN for a group of UEs its respective switch-on period ends after a predetermined threshold time Tₜₕ, wherein the predetermined threshold time Tₜₕ may be determined based on information about the QoS of one or more services running in the UEs of the group and/or a status of data buffers of the UEs of the group.

In step 950, MN 110 transmits to each UE of each group of UEs new connection information for establishing a new second connection between the respective UE and a new SN that was determined for the respective group.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

The benefits and advantages that may be provided by the present disclosure have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements and may include other elements not expressly listed or inherent to the claimed embodiment.

While the present disclosure has been described with reference to particular embodiments, it should be understood that the embodiments are illustrative and that the scope of the present disclosure is not limited to these embodiments. Many variations, modifications, additions, and improvements to the embodiments described above are possible. It is contemplated that these variations, modifications, additions and improvements fall within the scope of the present disclosure as detailed within the following claims.

One or more embodiments of the present disclosure may also be described by the following: the present disclosure relates to a User Equipment UE having a connection with a Master Node (MN) and a Secondary Node (SN). The SN notifies the UE of an upcoming switched-off period, in which it will not be available for communication with the UE. If the UE needs to communicate with a SN during that period, it will try to establish a new connection with a new SN. To do so, it will send information about its communication-on period, in which it needs to communicate with a SN, and information about the switch-off period to its MN. The MN will determine one or more possible new SNs on the basis of the information about the communication-on period of the UE and information about the switch-on periods of other SNs. The MN send information about possible new SNs to the UE, which selects one of those for establishing a new connection.

1. Method for improving a data connection of a UE (User Equipment) in a mobile network, the method comprising:
establishing a first connection between the UE and a MN (Master Node) of the mobile network;
receiving, from the MN using the first connection, connection information for establishing a second connection between the UE and a SN (Secondary Node);
establishing a second connection between the UE and the SN based on the connection information,
wherein during a communication-on time period the UE is to communicate with the SN and during a communication-off time period the UE is not to communicate with the SN;
wherein during a switch-on time period the SN is able to communicate with the UE and during a switch-off time period the SN is unable to communicate with the UE;
receiving a switch-off message from the SN using the second connection, indicating an upcoming switch-off period of the SN;
determining a mismatch between the upcoming switch-off period of the SN and a communication-on period of the UE;
in response to a determined mismatch, the method further comprises:
a) at least one of sending an extension request to the SN, wherein the request comprises an extension time for extending its switch-on;
or b) sending information about the communication-on period and information about the upcoming switch-off period, to at least one of the MN using the first connection or the SN using the second connection, wherein the SN is arranged for forwarding the information to the MN using a third connection between the SN and the MN;
receiving from the MN new connection information for establishing a new second connection between the UE and a new SN, wherein the new connection information comprises information about at least one new SN;
selecting a new SN from the at least one new SN; and
establishing a new second connection with the selected new SN.

2. Method according to claim 1, wherein step b) further comprises:
generating a Measurement Report (MR), comprising information about the a quality of signals from the MN, the SN;
sending the MR to at least one of the MN and/or the SN;
wherein the information about the upcoming switch-off period is sent as a part of the MR, or wherein the switch-off message, which comprises the information about the upcoming switch-off period, is sent as a part of the MR.

3. Method according to claim 1, wherein the selecting a new SN from the at least one new SN is based on a quality of the signals from the respective new SN.

4. Method for improving a data connection of a UE (User Equipment) in a mobile network, the method comprising:
establishing a first connection between the UE and a MN (Master Node) of the mobile network;
transmitting, to the UE using the first connection, connection information for establishing a second connection between the UE and a SN (Secondary Node);
wherein during a communication-on time period the UE is to communicate with the SN and during a communication-off time period the UE is not to communicate with the SN;
wherein during a switch-on time period the SN is able to communicate with the UE and during a switch-off time period the SN is unable to communicate with the UE;
receiving information about a communication-on period of the UE and information about an upcoming switch-off period of the SN, from the UE using the first connection or from the SN using a third connection, wherein the SN is arranged for forwarding the information received from the UE to the MN using a third connection between the SN and the MN;
receiving information from one or more other SNs, indicating at least one of its respective current switch-on period and/or upcoming switch-off period;
determining one or more new SNs on the basis of one or more predetermined criteria; and
transmitting to the UE new connection information for establishing a new second connection between the UE and a new SN, wherein the new connection information comprises information about the determined one or more new SNs.

5. Method according to the preceding claim 4, wherein the predetermined criteria comprises at least one of a group comprising:
for each new SN, the respective switch-on period thereof ends after the communication-on period;
for each new SN, the respective switch-on period thereof ends after a predetermined threshold time Tₜₕ, wherein the predetermined threshold time Tₜₕ is determined based on information about at least one of a the QoS (Quality of Service) of one or more services running in the UE and/or a status of a data buffer in the UE; and
for each new SN, a respective expected data load thereof is below a predetermined threshold load.

6. Method for improving a data connection of a group of multiple UEs (User Equipment) in a mobile network, the method comprising:
establishing multiple first connection between the multiple UEs and a MN (Master Node) of the mobile network;
transmitting, to each of the multiple UEs using the multiple first connections, respective connection information for establishing second connections between a respective UE and a respective SN (Secondary Node);
wherein during a communication-on time period a UE of the multiple UEs is to communicate with the SN and during a communication-off time period the UE is not to communicate with the SN;
wherein during a switch-on time period a SN of said multiple SNs is able to communicate with its UEs and during a switch-off time period the SN is unable to communicate with the multiple UEs;
receiving information about an upcoming switch-off periods of one or more SNs of the multiple SNs;
grouping the one or more UEs in one or more groups on the basis of one or more grouping criteria;
determining a new SN for each group of UEs on the basis of one or more predetermined criteria; and
transmitting to each UE of each group of UEs new connection information for establishing a new second connection between the respective UE and a new SN that was determined for the respective group.

7. Method according to claim 1, wherein the grouping criteria may be based on at least one of a group comprising:
an end of communication-on period of the respective UE;
QoS (Quality of Service) of one or more services running in the respective UE;
status of an upload data buffer in the respective UE,
status of a download buffer for the UEs.

8. Method according to claim 6, wherein the predetermined criteria comprise at least one of a group comprising:
for each new SN for a group of UEs, the respective switch-on period thereof ends after all communication-on period of all UEs in the group;
for each new SN for a group of UEs, the respective switch-on period thereof ends after a predetermined threshold time Tₜₕ, wherein the predetermined threshold time Tₜₕ is determined based on information about at least one of the QoS of one or more services running in the UEs of the group or a status of data buffers of the UEs of the group.

9. Method for improving a data connection of a UE (User Equipment) in a mobile network, the method comprising:
establishing a second connection between the UE and an SN,
wherein during a communication-on time period the UE is to communicate with the SN and during a communication-off time period the UE is not to communicate with the SN;
wherein during a switch-on time period the SN is able to communicate with the UE and during a switch-off time period the SN is unable to communicate with the UE;
sending a switch-off message to the UE using the second connection, indicating an upcoming switch-off period of the SN;
wherein the method further comprises the following steps at least one of:
a) receiving an extension request from the UE, wherein the request comprises an extension time, and extending the current switch-on period with the extension time; or
b) receiving information about a communication-on period and information about an upcoming switch-off period from the UE using the second connection and forwarding the information to the MN using a third connection between the SN and the MN.

10. Method according to claim 9, wherein the information about the upcoming switch-off period is received and forwarded as a part of a Measurement Report, generated by the UE.

11. Method according to claim 9, wherein at least one of the first connection is a cellular mobile network connection, and/or the second connection is a cellular mobile network connection, or the third connection is one of a group comprising: a wireless connection and a wired connection.

12. Method according to claim 9,
wherein the communication-on period of a UE is a DRX-on period and the communication-off period of a UE is a DRX-off period; and,
wherein the information about the communication-on period is sent as part of DRX (Discontinuous Reception) configuration information;
wherein the DRX-on period and the DRX-off period are determined by the MN based on DRX configuration parameter information.

13. A User Equipment arranged for operating in a mobile network, comprising:
at least one communication unit establishing connections between the UE and a Master Node and between the UE and a SN;
a processing unit comprising a processor for carrying out steps of a computer program;
a computer-readable medium having stored thereon the computer program, comprising instructions which, when the program is executed by the processing unit processor, cause the UE to carry out the method of claim 1.

14. A network node arranged for operating in a mobile network, comprising:
at least one communication unit establishing connections between the node and at least one UE and between the node and at least one other node;
a processing unit comprising a processor for carrying out steps of a computer program;
a computer-readable medium having stored thereon the computer program, comprising instructions which, when the program is executed by the processing unit processor, cause the node to carry out the method of any of claim 4.

15. A non-transitory computer-readable medium having stored thereon a computer program, comprising instructions which, when the program is executed by a computer, cause the computer to carry out the method of any of claim 1.

16. The method according to claim 11, wherein the wired connection is an X2 connection.
